(19) United States
(12) Patent Application Publication
(10) Pub. No.: US 2012/0221709 A1
(43) Pub. Date: Aug. 30, 2012

(54) MECHANISM TO ALLOW HOSTED AND ON-SITE IMPLEMENTATIONS TO MANAGE PRODUCT ASSETS AS SPECIFIED BY A THIRD PARTY

(76) Inventors: James R. Bowes, Dartmouth (CA); Justin Harris, Ann Arbor, MI (US)

(21) Appl. No.: 13/034,115

(22) Filed: Feb. 24, 2011

(51) Int. Cl. G06F 15/173

(52) U.S. Cl. 709/224

(57) ABSTRACT

A first server computing system receives a request from a second server computing system over a first network. The request is for product asset management data relating to an owner of product assets. The product asset management data comprises product business model data of a third party. The first computing system collects the product asset management data relating to the owner and sends the product asset management data to the second server computing system to allow the second server computing system to manage the product assets of the owner as specified by the third party via a second network.

### TECHNICAL FIELD

Embodiments of the present invention relate to product asset management. Specifically, the embodiments of the present invention relate to allowing hosted and on-site implementations to manage product assets as specified by a third party.

### BACKGROUND

A software provider can sell software and/or service products, for example, by selling subscriptions to customers for the products. An entity that has purchased a product subscription is an owner of the subscription and has a right to use the product for the period of the subscription. An owner's use of a subscription can be represented, for example, as an ‘entitlement.’ For example, a customer, such as ACME Company, purchases ten 3-year subscriptions to Enterprise Software ABC. ACME Company is the owner of the ten subscriptions, which can be represented by ten entitlements, and can assign the ten entitlements to various systems. When a system is granted an entitlement, the system can receive product updates for the Enterprise Software ABC.

Product asset management tools are provided to allow software providers and customers to manage the product subscriptions that have been purchased, the subscriptions that have been consumed, the patches, updates, and maintenance of the products, etc. Conventional product asset management tools allow software providers to remotely manage the product assets of its customers, such as customer ACME Company, via a public network. Large customers, such as Beta Company, may wish to manage their product assets in a secure fashion within their own private network, but do not have the means to manage their product assets locally within their own network environment.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 is an exemplary network architecture in which embodiments of the present invention may operate.

FIG. 2 is a block diagram of one embodiment of an export subsystem for exporting product asset management data to allow on-site implementations of product asset management.

FIG. 3 is a block diagram of one embodiment of an import subsystem for importing product asset management data to allow on-site implementations of product asset management.

FIG. 4 is a ladder diagram of an embodiment of a method for allowing on-site implementations of product asset management.

FIG. 5 is a flow diagram of an embodiment of a method for exporting product asset management data to allow on-site implementations of product asset management.

FIG. 6 is a flow diagram of an embodiment of a method for importing product asset management data and managing product assets on-site as specified by a third party.

FIG. 7 is a diagram of one embodiment of a computer system for allowing hosted and on-site implementations to manage product assets as specified by a third party.

### DETAILED DESCRIPTION

Embodiments of the invention are directed to a method and system for allowing hosted and on-site implementations to manage product assets as specified by a third party. A first server computing system receives a request from a second server computing system over a first network. The request is for product asset management data relating to an owner of product assets. The product asset management data comprises product business model data of a third party. The first computing system collects the product asset management data relating to the owner and sends the product asset management data to the second server computing system to allow the second server computing system to manage the product assets of the owner as specified by the third party via a second network.

Conventional product asset management tools allow software providers to remotely manage the product assets of its customers. Customers, however, may wish to manage their product assets within their own private network. Embodiments of the present invention provide customers with product asset management data to support an on-site implementation of product asset management.

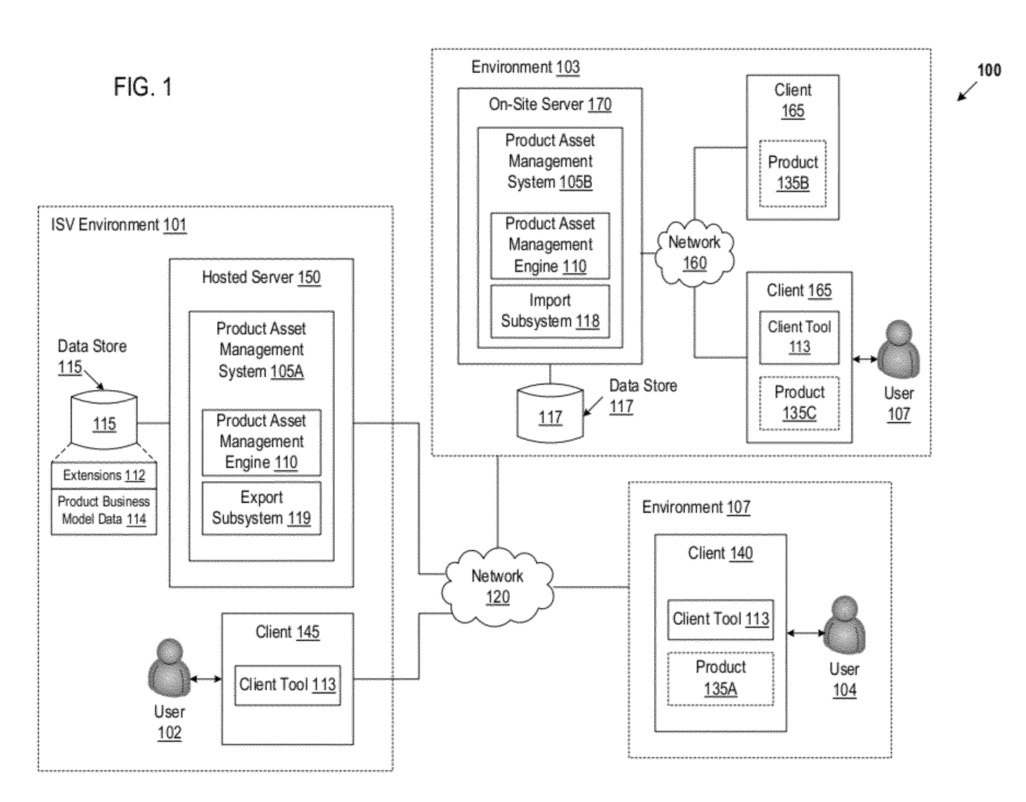

FIG. 1 is an exemplary network architecture 100 in which embodiments of the present invention can be implemented. Embodiments of the invention are directed to a method and system for allowing hosted and on-site implementations to manage product assets as specified by a third party. The network architecture 100 can include a software provider environment, such as an independent software vendor (ISV) environment 101, communicating with one or more customer environments 103,107 via a network 120. In one example, a customer environment 107 includes clients 140 communicating with the server 150 via the network 120. In another example, a customer environment 103 includes a server 170 that communicates with the server 150 via the network 120, and the server 170 that communicates with clients 165 via a separate network 160. The networks 120,160 can be a local area network (LAN), such as an intranet within a company, a wireless network, a mobile communications network, a wide area network (WAN), such as the Internet, or similar communication system. The networks 120,160 can include any number of networking and computing devices such as wired and wireless devices.

Software providers can develop and/or sell software and/or service products. A software provider can be a large software company that develops and sells operating system platforms, an ISV that develops and sells specialized software to run on an operating system platform, and/or an independent service provider (ISP) that does not develop, but sells products. For brevity and simplicity, an ISV is used as an example of a software provider throughout this document.

Customers that purchase subscriptions are owners of the subscriptions. A subscription purchase is an owner's right to use the product for the period of the subscription. An owner's use of a subscription can be represented, for example, as an ‘entitlement.’ Software may or may not already be installed on an entity. Software that is already installed on an entity can be somewhat usable, even if the entity is not granted an entitlement for the installed software. When an entity is granted an entitlement for the software, the entity can access a product repository to receive software updates. For example, an ISV develops and sells Enterprise Software ABC. A customer, ACME Company, purchases ten 3-year subscriptions to Enterprise Software ABC, which is represented by ten entitlements. ACME Company may already have the Enterprise Software ABC already installed in one or more of its systems. When a system is granted an entitlement for the Enterprise Software ABC, the system can receive updates for the Enterprise Software ABC.

A consumer is an entity that has been granted an entitlement to allow the entity to receive product updates. For example, when an entity is granted an entitlement for the Enterprise Software ABC, the entity is a consumer of the Enterprise Software ABC. Examples of entities include, and are not limited to, a person, a client computing system, a server computing system, a domain, etc.

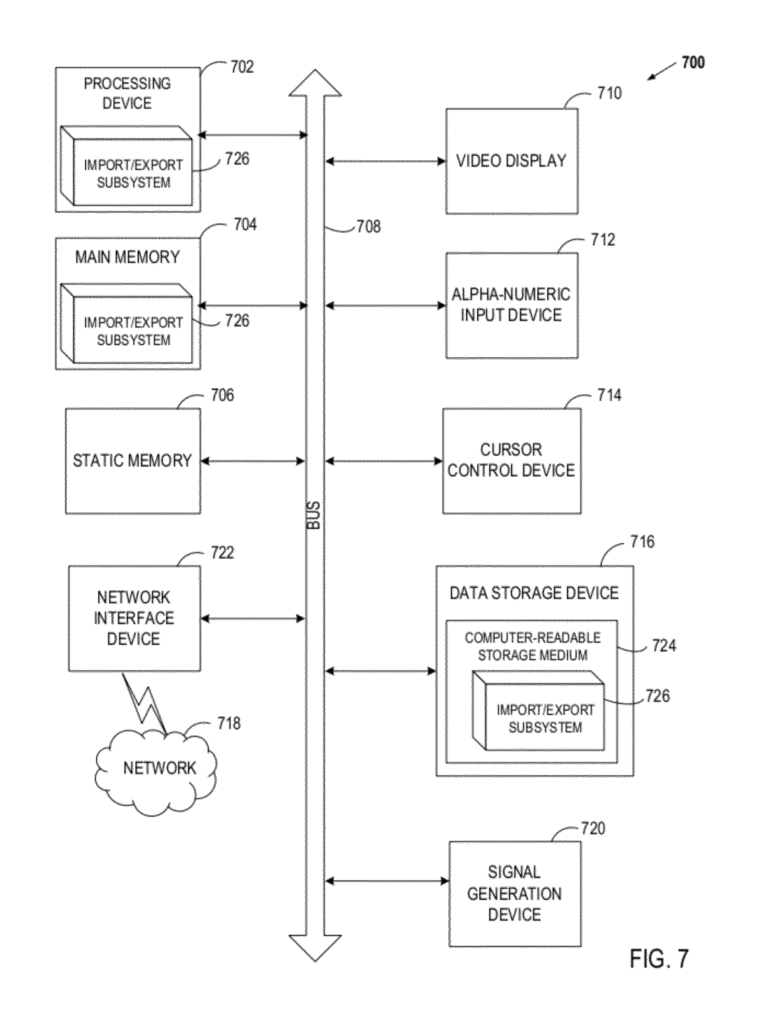

Software providers and customers can track which product subscriptions have been purchased and which of the purchased subscriptions have been consumed. The tracking of purchased and consumed products is hereinafter referred to as ‘product asset management.’ Product asset management can also include tools to manage the consumers in their environments. These tools may, for example, allow system administrators to manage patches, updates, monitoring and maintenance of the entitlements, etc. A software provider environment, such as ISV environment 101, can include a server 150 that hosts a product asset management system 105A for managing product assets in the one or more customer environments 103,107. The product asset management system 105A can include, for example, a Java web application based on a REST (Representational State Transfer) client-server architecture that exposes a REST API. A server 150 can be hosted by any type of computing device including server computers, gateway computers, desktop computers, laptop computers, hand-held computers or similar computing device. An exemplary computing device is described in greater detail below in conjunction with FIG. 7.

A product asset management system 105A,B can include a product asset management engine 110 that allows third parties (e.g., independent software vendor (ISV), independent service provider (ISP), etc.) to customize product business model data and to manage product assets as specified by the custom business model data. The third party is a third party to a developer of the product asset management engine 110. Examples of product business model data can include, and are not limited to, subscription data, product data, entitlement data, identity data, event publishing data, user data, business rules, batch job data, etc. The product asset management engine 110 enables third parties to specify the product business model data that is of interest to the third party. For example, a third party, such as an ISV, can specify which products are to be managed and which business models to use. In one embodiment, the product asset management engine 110 replaces default product business model data with the custom product business model data of the third party.

In one embodiment, the product asset management system 105A provides a hosted solution where, for example, an ISV environment 101 remotely manages product assets of its customer environments, such as a small customer ACME Company environment 107, via a public network 120. The code of the product asset management engine 110 can include extension points to call extensions 112 to enable third parties to specify the product business model data to use in remotely managing product assets. An extension point is a predefined point in the program code (e.g., product asset management engine 110 code) where the application developer intended to enable third parties to add extensions to customize behavior at that point. An extension can be third party program code to extend the behavior of other program code at the extension points in the other program code.

The hosted product asset management system 105A can be coupled to one or more data stores 115 that store the product business model data 114 for its customers (e.g., ACME Company, Beta Company, etc.). The product business model data 114 can include subscription data that indicates which product assets a customer has purchased and consumed, as well as other data for managing the product assets. A client, such as client 140 in environment 107, can communicate remotely with the hosted product management system 105A over the public network 120 to, for example, determine which product subscriptions are available to the client 140 and to request an entitlement for a product 135A for the client 140. The hosted product management system 105A can receive the request and determine, based on the product business model data 114 in data store 115, whether to grant the client 140 an entitlement for a product 135A.

Larger customers, such as Beta Company in environment 103, may wish to manage their product assets using an on-site product asset management solution within their own network 160. In one embodiment, the product asset management system 105B provides an on-site product asset management solution. An on-site product asset management solution can include an on-site server 170 and a private network 160. The on-site server 170 can be maintained by the owner of the product assets, such as customer Beta Company. The network 160 can be a private network only available to systems in environment 103. The hosted product asset management system 105A in the ISV environment 101 can include an export subsystem 119 to export product asset management data to the on-site product asset management system 105B via network 120 to allow the on-site server 170 to locally manage product assets within the environment 103. Examples of product asset management data can include, and are not limited to, third party product business model data 114 for a particular owner, third party extensions 112, and client configuration data, etc. A server 170 can be hosted by any type of computing device including server computers, gateway computers, desktop computers, laptop computers, hand-held computers or similar computing device. An exemplary computing device is described in greater detail below in conjunction with FIG. 7.

The on-site product asset management system 105B can include an import subsystem 118 to import the product asset management data (e.g., third party product business model data 114, third party extensions 112, client configuration data, etc.) from the hosted product asset management system 105A. The on-site server 170 can store the imported data locally in a data store 117 that is coupled to the on-site server 170. The clients 165 in the customer environment 103 can communicate with the on-site server 170 via the private network 160 to consume the purchased products 135B,C. The on-site server 170 can locally store data of the products consumed by the clients 165 in the data store 117.

The export subsystem 119 and import subsystem 118 can support a multi-tenant environment. For example, environment 103 can be maintained by an independent service provider (ISP) that services a number of customers. The ISP hosts the on-site server 170 but is not the owner of the product assets (e.g., entitlements). Each of the ISP customers is an owner. The import subsystem 118 in the on-site server 170 of the ISP can request the product asset management data for an owner from the hosted server 150 on behalf of the owner and import the product asset management data for the owner. The import subsystem 118 can create multiple tenants, or owners, and consume and import product asset management data for the one or more owners from the hosted server 150.

In one embodiment, a product asset management system 105A,B exposes a programmatic REST interface, which a client tool 113 hosted by a client can communicate with. In one embodiment, a client tool 113 can be any kind of tool which could communicate with the REST interface. For example, a user 102, such as an ISV system administrator, can use the client tool 113 to communicate with the hosted product asset management system 105A to manage patches, update, monitoring, and maintenance of the consumers in a customer environments 107. In another example, a user 104, such as an ACME Company system administrator, can use the client tool 113 to communicate remotely with the hosted product asset management system 105 via network 120 to consume a product 135A. In another example, a user 107, such as a Beta Company system administrator can use the client tool 113 to communicate locally with the on-site server 170 to consume a product 135C. Other examples of a client tool 113, can include and are not limited to, a web interface, web browser, or other client software that can communicate with the REST interface. The client machines can be hosted by any type of computing device including server computers, gateway computers, desktop computers, laptop computers, mobile communications devices, cell phones, smart phones, hand-held computers, or similar computing device. An exemplary computing device is described in greater detail below in conjunction with FIG. 7.

A data store 115,117 can be a persistent storage unit. A persistent storage unit can be a local storage unit or a remote storage unit. Persistent storage units can be a magnetic storage unit, optical storage unit, solid state storage unit, electronic storage units (main memory), or similar storage unit. Persistent storage units can be a monolithic device or a distributed set of devices. A ‘set’, as used herein, refers to any positive whole number of items.

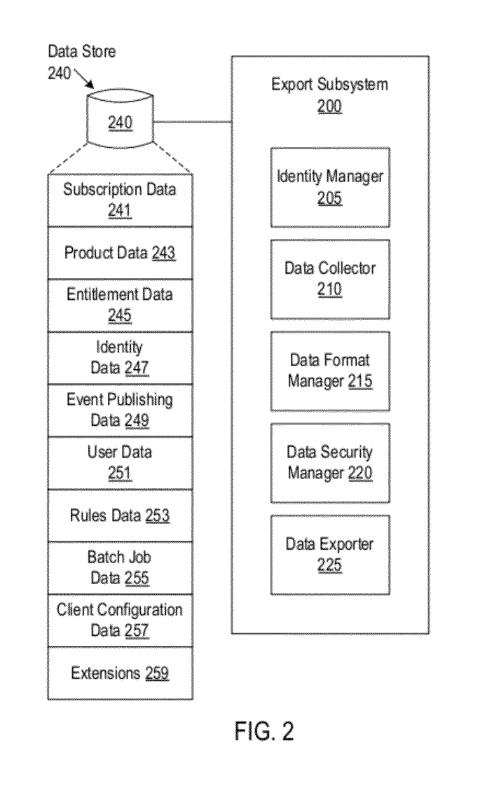

FIG. 2 is a block diagram of one embodiment of an export subsystem 200 for exporting product asset management data to allow on-site implementations of product asset management. The export subsystem 200 can be the same as the export subsystem 119 in a product management system 105A hosted by a hosted server 150 of FIG. 1. The export subsystem 200 can include an identity manager 205, a data collector 210, a data format manager 215, a data security manager 220, and a data exporter 225.

A third party, such as an ISV, can provide and/or specify the product business model data to be used for managing product assets. Examples of product business model data can include, and are not limited to, subscription data 241, product data 243, entitlement data 245, identity data 247, event publishing data 249, user data 251, rules data 253, batch job data 255, etc. The export subsystem 200 can be coupled to one or more data stores 240 that store the product business model data. The product business model data can be stored in one or more tables in a database. The product business model data can be existing internal data, for example, that is maintained by a sales department and/or accounting department of the third party.

Examples of subscription data 241 can include, and are not limited to, data representing the products that owners have purchased, the quantity of the purchased products, the time period the purchase is valid for, etc. Product data 243 defines the products to be managed and can include product attributes and the attribute values. Examples of product attributes can include, and are not limited to, the architecture types, the number of CPU sockets, the number of cores/CPU that are supported by a product. The entitlement data 245 is data that can define the representation of an entitlement to be granted to an entity. The identity data 247 can define how entities identify themselves with the product asset management system. For example, the identity data 247 can include identity certificates to assign to registered entities. Event publishing data 249 can define how the product asset management system should publish events. User data 251 can define how the product asset management system should authorize and authenticate users. Rules data 253 can specify (e.g., using pluggable Javascript) what is the “best” product for the consumer to be subscribed to and can control whether a consumer can consume an entitlement to a subscribed product. Batch job data 255 can define how the product asset management system should handle batch jobs.

When an entity (e.g., a server) in a customer environment registers with a hosted product asset management system (e.g., hosted product asset management system 105A in FIG. 1), the entity can register as an on-site server to manage product assets as specified by a third party (e.g., ISV) and locally within the customer environment. The export subsystem 200 can receive registration data from the entity indicating that the entity is registering as an on-site server and associating the on-site server with a particular owner. The registration data can include identity data for the on-site server, such as an identity certificate, to authenticate the on-site server with the export subsystem 200. The identity manager 205 can compare the identity certificate received in the registration data to the identity data 247 stored in the data store 240 to validate the on-site server's identity.

The data collector 210 can determine what product assets the on-site server is entitled to and can assign a number of the owner's entitlements to the on-site server. The data collector 210 can make the determination based on the product data 243, subscription data 241, and rules data 253 that are associated with the owner. The data collector 210 can mark the entitlements, which are to be exported to the on-site server, as consumed in the entitlement data 245. The rules data 253 can limit the number of entitlements to export to the on-site server. The entitlements that are assigned to the on-site server can include an “on-site server” entitlement that is consumed by the on-site server itself to allow it to manage product assets locally, as well as the “product” entitlements which the on-site server can assign to various entities to consume.

The data collector 210 can use the an owner identifier in the registration data to collect the product asset management data that is associated with the owner. The product asset management data can include third party extensions 259 associated with the owner, third party product business model data associated with the owner stored in the one or more data stores 240, and client configuration data 257. The data collector 210 can generate the client configuration data 257 for the on-site server. The client configuration data 257 can be a client configuration file which the on-site server uses to configure entities to communicate locally with the on-site server to consume a product. The third party extensions 259 and third party product business model data can include an owner identifier specifying which owner the data is associated with. For example, an ISV maintains a Hosted_Server to manage the product assets for twelve different owners, and provides the extensions 259 and specifies the product business model data to use to manage the product assets Customer_Three wishes to manage its own product assets in its own network and deploys On-Site_Server_A for managing its own product assets. On-Site_Server_A registers itself with the Hosted_Server as an on-site server and the data collector 210 residing in the Hosted_Server collects the extensions 259 and product business model data specified by the ISV and associated with Customer_Three.

The data format manager 215 can format the product asset management data into a compressed format, such as a zip file. The metadata for the formatted product asset management data can be in a data interchange format, such as a JSON (Javascript Object Notation) file format, XML data format, or other similar formats. The data security manager 220 can implement a digital signature for the formatted product asset management data. A valid digital signature gives a recipient (e.g., on-site server) reason to believe that the message was created by a known sender (e.g., hosted server), and that it was not altered in transit. The data security manager 220 can also include an identity certificate of the hosted server in the product asset management data that is to be sent to the on-site server to allow the on-site server to authenticate the identity of the hosted server. The data exporter 225 can export the signed product asset management data to the on-site server to allow the on-site server to manage products assets as specified by the third party (e.g., ISV) within a private network environment.

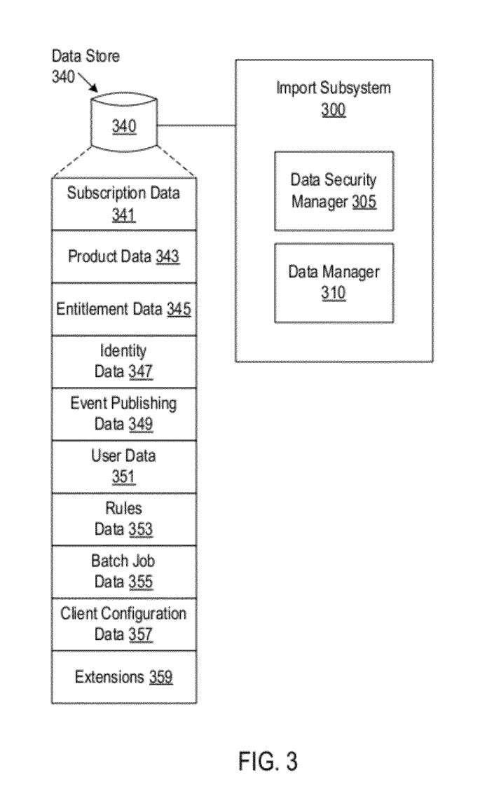

FIG. 3 is a block diagram of one embodiment of an import subsystem 300 for importing product asset management data to allow on-site implementations of product asset management. The import subsystem 300 can be the same as the import subsystem 118 in a product management system 105B hosted by an on-site server 170 of FIG. 1. The import subsystem 300 can include a data security manager 305 and a data manager 310.

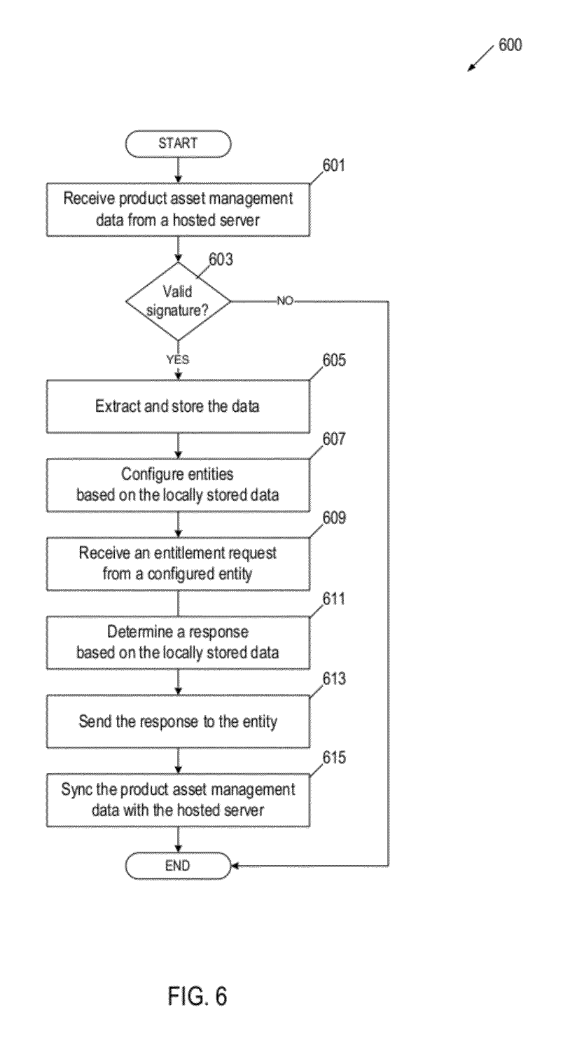

The import subsystem 300 can receive product asset management data from a hosted server. The product asset management data includes product business model data as specified by a third party, third party extensions, and client configuration data. The data security manager 305 can validate the digital signature received in the product asset management data to validate that the data was sent by the hosted server. The data security manager 305 can reject the data if the digital signature is not valid. If the signature is valid, the data manager 310 can extract the third party product business model data, third party extensions 359, and client configuration data 357, from the imported data to one or more data stores 340 that are coupled to the import subsystem 300. Examples of third party product business model data can include, and are not limited to, subscription data 341, product data 343, entitlement data 345, identity data 347, event publishing data 349, user data 351, rules data 353, batch job data 355, etc. One embodiment for using the extracted product asset management data to manage product assets locally is described in greater detail below in conjunction with FIG. 6.

The data manager 310 can use the client configuration data 357 to configure the entities, which are to be managed, to communicate with the on-site product asset management system for consuming a product, rather than having the entities communicate with a hosted server. The client configuration data 357 can be a configuration file. The data manager 310 can synchronize the product asset management data with the hosted product asset management system. The data manager 310 can send a request for the product asset management data to the hosted product asset management system.

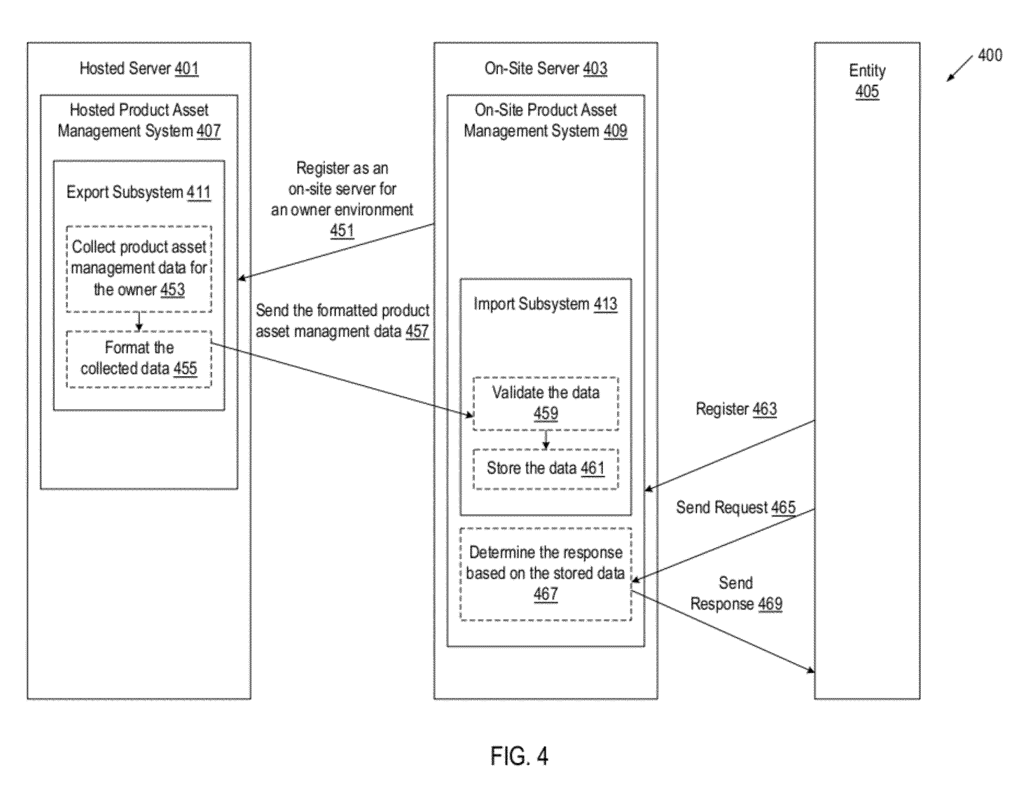

FIG. 4 is a ladder diagram of an embodiment of a method 400 for allowing on-site implementations of product asset management. In one embodiment, the method 400 begins with an on-site server 403 registering itself as a on-site server with a hosted product asset management system 407 at block 451.

The export subsystem 411 collects the product asset management data that is associated with the owner at block 453. The product asset management data can include for example, and is not limited to, third party extensions, third party product business model data, and client configuration data. The export subsystem 411 can generate client configuration data for the on-site server to use to configure entities to communicate with the on-site server. The product asset management system 407 can be coupled to one or more data stores that store the third party extensions and third party product business model data. The export subsystem 411 formats the product asset management data at block 455, and exports the formatted data to the on-site server 403 at block 457. For example, the export subsystem 411 compresses the data, implements a digital signature for the data, and sends the secured data to the on-site server 403.

The import subsystem 413 receives the product asset management data and validates the digital signature at block 459. The import subsystem 413 rejects the product asset management data if the digital signature is invalid and locally stores the product asset management data in one or more data stores that are coupled to the import subsystem 413 at block 461 if the digital signature is valid. An entity 405, such as a client in Beta Company's network, registers itself with the on-site product asset management system 409 at block 463, and sends a request at block 465. The request can be for a list of product subscriptions that are available to the entity 405 or for an entitlement for a particular product for the entity 405. The on-site product asset management system 409 can determine the response to the request based on the product asset management data that is locally stored at block 467, and send the response to the entity 405 at block 469.

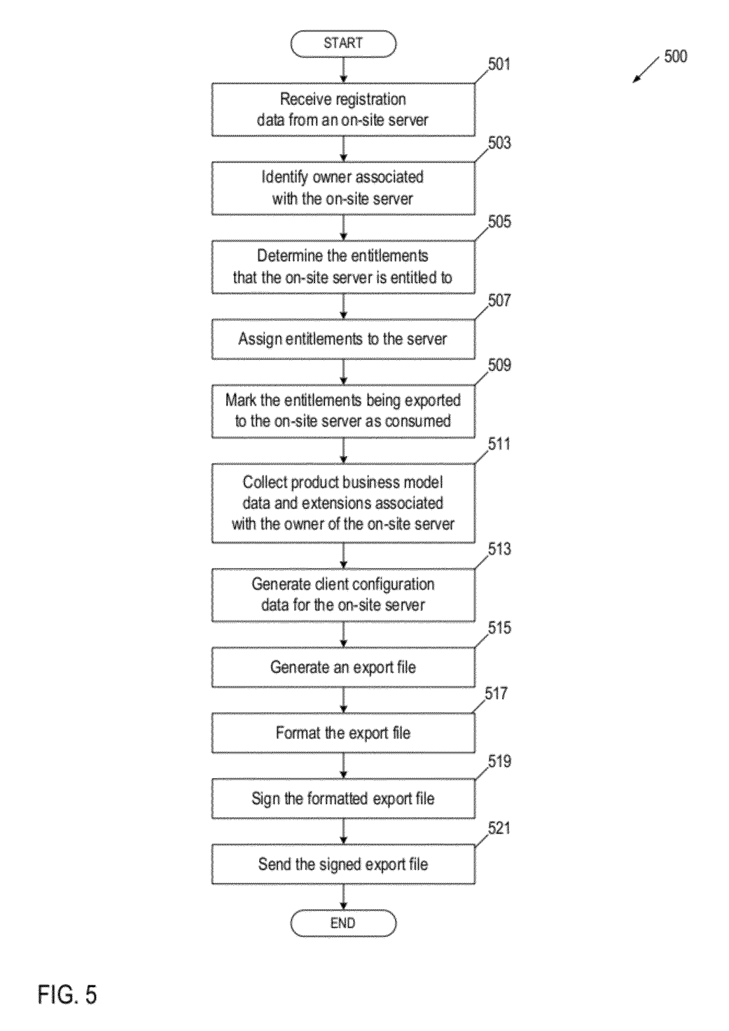

FIG. 5 is a flow diagram of an embodiment of a method 500 for exporting product asset management data to allow on-site implementations of product asset management. Method 500 can be performed by processing logic that can comprise hardware (e.g., circuitry, dedicated logic, programmable logic, microcode, etc.), software (e.g., instructions run on a processing device), or a combination thereof. In one embodiment, method 500 is performed by the export subsystem 119 in a product asset management system 105A hosted by a hosted server 150 of FIG. 1.

In one embodiment, the method 500 begins with the hosted product asset management system receiving a request from an on-site server over a network for product asset management data relating to an owner of product assets. The request can be in the form of registration data from the on-site server indicating that the on-site server is registering as an on-site server to locally manage the product assets of an owner. The hosted product asset management system can store the registration data in a data store that is coupled to the hosted product asset management system at block 501. At block 503, the product asset management system identifies the owner that is associated with the on-site server. The registration data can identify the owner which the on-site server is associated with. For example, the registration data identifies that the on-site server is associated with owner, Beta Company.

At block 505, the product asset management system determines which entitlements the on-site server is entitled to and assigns the entitlements to the on-site server at block 507. The entitlements that are assigned to the on-site server can include an “on-site server” entitlement that is consumed by the on-site server itself to allow the server to manage product assets locally, as well as the “product” entitlements which the on-site server can assign to various entities to consume. The product asset management system can make the determination based on the product data, subscription data, and rules data that are associated with the owner. The rules data can limit the number of entitlements to export to the on-site server. At block 509, the export subsystem marks the entitlements, which are to be exported to the on-site server, as consumed in the entitlement data. For example, the product asset management system assigns an “on-site server” entitlement and 50 “product” entitlements from a pool to the on-site server and records data in a data store that is coupled to the export subsystem indicating the “on-site server” entitlement and the 50 “product” entitlements are ‘consumed’ by the on-site server. The on-site server actually consumes the “on-site server” entitlement and the 50 “product” entitlements can be consumed by other entities, as distributed by the on-site server. When the on-site server assigns one of the 50 entitlements to an entity, the on-site server can record data in a data store that is coupled to the on-site server indicating the assigned entitlement has been consumed by a particular entity.

At block 511, the export subsystem collects the third party product business model data and third party extensions that are associated with the owner. The extensions and product business model data can be stored in one or more data stores that are coupled to the data collector and can include ownership identifiers indicating which owner the extensions and product business model data are associated with. Examples of the third party extensions can include, and are not limited to a subscription data extension, a product data extension, an entitlement extension, an identity extension, an event publishing extension, a user data extension, a rules extension, a batch job extension, etc. When the on-site server imports the extensions, and the on-site product asset management system detects an extension point, the on-site product asset management system can call the third party extension that is associated with the extension point.

At block 513, the export subsystem generates client configuration data for the on-site server. The client configuration data can be a client configuration file to be installed in each entity, which is to be managed by the on-site server, to configure the entities to communicate locally with the on-site server. At block 515, the export subsystem generates an export file that includes the product asset management data (e.g., extensions, product business model data, and the client configuration data). The export subsystem can include an identity certificate of the hosted server in the export file to allow the on-site server to authenticate the identity of the hosted server.

At block 517, the export subsystem formats the product asset management data into a compressed format, such as a zip file. The metadata for the data can be in a data interchange format, such as a JSON (Javascript Object Notation) file format, XML data format, or other similar formats. At block 519, the export subsystem can implement a digital signature for the formatted product asset management data and export the product asset management data to the on-site server at block 521. A valid digital signature gives the on-site server confirmation that the product asset management data was created by a known sender (e.g., hosted server), and that it was not altered in transit.

FIG. 6 is a flow diagram of an embodiment of a method 600 for importing product asset management data and managing product assets on-site. Method 600 can be performed by processing logic that can comprise hardware (e.g., circuitry, dedicated logic, programmable logic, microcode, etc.), software (e.g., instructions run on a processing device), or a combination thereof. In one embodiment, method 600 is performed by the import subsystem 118 in a product asset management system 105B hosted by an on-site server 170 of FIG. 1.

In one embodiment, the method 600 begins with the on-site server receiving the product asset management data exported from the hosted server at block 601. At block 603, the on-site product asset management system determines whether the signature included in the product asset management data is valid. The on-site product asset management system can be coupled to a data store that stores a signature key associated with the hosted server and can use the signature key to validate the signature in the product asset management data. If the signature is not valid (block 603), the on-site product asset management system rejects the product asset management data and can send a message to the hosted server indicating the signature is invalid.

If the signature is valid (block 603), the import subsystem extracts and stores the product asset management data (e.g., third party extensions, third party product business model data, client configuration data) from the imported data and stores the data in the data store at block 605. The product business model is specified by a third party (e.g., ISV). Examples of product business model data can include, and are not limited to, subscription data, product data, entitlement data, identity data, event publishing data, user data, rules data, batch job data, etc. The product business model data can be stored as tables in the data store.

The import subsystem configures entities to be managed by the on-site product asset management system with the extracted client configuration file at block 607. The client configuration file points the entities to communicate with the on-site server and to locally stored product business model data (e.g., tables in the data store) in order to consume products. The import subsystem also extracts the identity data, such as a number of identity certificates, from the imported to the data store, and the on-site product asset management system can distribute the identity certificates to entities that register with the on-site product asset management system. At block 609, the on-site product asset management system receives a request from an entity. The request can be a request for a list of product subscriptions that are available to the entity and/or a request to grant an entitlement for a particular product to the entity. For example, a Beta Company system administrator wishes an entity to have access to a product repository for the Enterprise Software ZZZ, and the on-site product asset management system receives a request for an entitlement for Enterprise Software ZZZ.

At block 611, the on-site product asset management system determines the response to the request based on the locally stored product asset management data (e.g., third party extensions, third party product business model data). For example, the on-site product asset management system can include a product asset management engine that supports extension points which call the extensions that are locally stored in the data store. For instance, the product asset management engine includes a rules extension point, which calls a rules extension stored in the data store, and the rules extension executes a rules script that is part of the rules data in the data store. The on-site product asset management system can use the extensions and/or the rules data, product data, and subscriptions that is locally stored in the data store to determine the response to the request, such as whether to grant the entitlement to the entity. If the on-site product asset management system determines to grant the entitlement to the entity, the on-site product asset management system can use the entitlement data that is locally stored in the data store to generate a representation of an entitlement for the entity and mark the entitlement as consumed in the locally stored entitlement data. The on-site product asset management system sends a response, such as granting the entitlement or a message indicating the request is refused, to the entity at block 613.

At block 615, the import subsystem synchronizes the imported data with the hosted product asset management system. The import subsystem can automatically and periodically send a request for the product asset management data to the hosted product asset management system. For example, the import subsystem can monitor the expiration dates pertaining to the entitlements being managed by the on-site server and request updated product asset management data from the hosted product asset management system prior to the expiration dates. The import subsystem can receive user input, for example from a system administrator, to update the product asset management data, and send a request for the export data to the hosted product asset management system.

FIG. 7 is a diagram of one embodiment of a computer system for allowing on-site implementations of product asset management. Within the computer system 700 is a set of instructions for causing the machine to perform any one or more of the methodologies discussed herein. In alternative embodiments, the machine may be connected (e.g., networked) to other machines in a LAN, an intranet, an extranet, or the Internet. The machine can operate in the capacity of a server or a client machine (e.g., a client computer executing the browser and the server computer executing the automated task delegation and project management) in a client-server network environment, or as a peer machine in a peer-to-peer (or distributed) network environment. The machine may be a personal computer (PC), a tablet PC, a console device or set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 700 includes a processing device 702, a main memory 704 (e.g., read-only memory (ROM), flash memory, dynamic random access memory (DRAM) such as synchronous DRAM (SDRAM) or DRAM (RDRAM), etc.), a static memory 706 (e.g., flash memory, static random access memory (SRAM), etc.), and a secondary memory 716 (e.g., a data storage device in the form of a drive unit, which may include fixed or removable computer-readable storage medium), which communicate with each other via a bus 708.

Processing device 702 represents one or more general-purpose processing devices such as a microprocessor, central processing unit, or the like. More particularly, the processing device 702 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. Processing device 702 is configured to execute the import/export subsystem 726 for performing the operations and steps discussed herein.

The computer system 700 may further include a network interface device 722. The computer system 700 also may include a video display unit 710 (e.g., a liquid crystal display (LCD) or a cathode ray tube (CRT)) connected to the computer system through a graphics port and graphics chipset, an alphanumeric input device 712 (e.g., a keyboard), a cursor control device 714 (e.g., a mouse), and a signal generation device 720 (e.g., a speaker).

The secondary memory 716 may include a machine-readable storage medium (or more specifically a computer-readable storage medium) 724 on which is stored one or more sets of instructions (e.g., the import/export subsystem 726) embodying any one or more of the methodologies or functions described herein. The import/export subsystem 726 may also reside, completely or at least partially, within the main memory 704 and/or within the processing device 702 during execution thereof by the computer system 700, the main memory 704 and the processing device 702 also constituting machine-readable storage media. The import/export subsystem 726 may further be transmitted or received over a network 718 via the network interface device 722.

The computer-readable storage medium 724 may also be used to store the import/export subsystem 726 persistently. While the computer-readable storage medium 724 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media.

The import/export subsystem 726, components and other features described herein (for example in relation to FIG. 1) can be implemented as discrete hardware components or integrated in the functionality of hardware components such as ASICS, FPGAs, DSPs or similar devices. In addition, the import/export subsystem 726 can be implemented as firmware or functional circuitry within hardware devices. Further, the import/export subsystem 726 can be implemented in any combination hardware devices and software components.

In the above description, numerous details are set forth. It will be apparent, however, to one skilled in the art, that the present invention may be practiced without these specific details. In some instances, well-known structures and devices are shown in block diagram form, rather than in detail, in order to avoid obscuring the present invention.

Some portions of the detailed description which follows are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “receiving,” “collecting,” “sending,” “determining,” “assigning,” “marking,” “storing,” “configuring,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the invention also relate to an apparatus for performing the operations herein. This apparatus can be specially constructed for the required purposes, or it can comprise a general purpose computer system specifically programmed by a computer program stored in the computer system. Such a computer program can be stored in a computer-readable storage medium, such as, but not limited to, any type of disk including optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems can be used with programs in accordance with the teachings herein, or it may prove convenient to construct a more specialized apparatus to perform the method steps. The structure for a variety of these systems will appear from the description below. In addition, embodiments of the present invention are not described with reference to any particular programming language. It will be appreciated that a variety of programming languages can be used to implement the teachings of embodiments of the invention as described herein.

A computer-readable storage medium can include any mechanism for storing information in a form readable by a machine (e.g., a computer), but is not limited to, optical disks, Compact Disc, Read-Only Memory (CD-ROMs), and magneto-optical disks, Read-Only Memory (ROMs), Random Access Memory (RAM), Erasable Programmable Read-Only memory (EPROM), Electrically Erasable Programmable Read-Only Memory (EEPROM), magnetic or optical cards, flash memory, or the like.

Thus, a method and apparatus for allowing on-site implementations of product asset management. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, implemented by a first server computing system programmed to perform the following, comprising:
receiving, by the first server computing system, a request from a second server computing system over a first network, the request being for product asset management data relating to an owner of product assets, the product asset management data comprising product business model data of a third party;
collecting, by the first server computing system, the product asset management data relating to the owner; and
sending, by the first server computing system, the product asset management data to the second server computing system to allow the second server computing system to manage the product assets of the owner as specified by the third party via a second network.

2. The method of claim 1, wherein the product asset management data further comprises at least one of: third party extensions and client configuration data.

3. The method of claim 1, further comprising:
determining entitlements that are available to the owner;
determining entitlements to send to the second server computing system; and
marking the entitlements to be sent to the second server computing system as consumed.

4. The method of claim 1, wherein the second network is a private network.

5. A method, implemented by a first server computing system programmed to perform the following, comprising:
receiving, by the first server computing system, product asset management data from a second server computing system over a first network, the product asset management data relating to an owner of product assets and comprising product business model data of a third party;
storing, by the first server computing system, the product asset management data in a data store that is coupled to the first server computing system; and
configuring, by the first server computing system, one or more entities in a second network to communicate with the first server computing system over the second network to manage the product assets of the owner as specified by the third party via the second network using the locally stored product asset management data, the second network being a private network.

6. The method of claim 5, wherein the product asset management data further comprises at least one of: third party extensions and client configuration data.

7. The method of claim 5, wherein configuring comprises:
configuring an entity, using the client configuration data, to communicate with the first server computing system over the second network to consume a product.

8. The method of claim 5, further comprising:
sending a request to the second computing system over the first network for updated product asset management data.

9. A server computing system comprising:
a persistent storage unit to store product asset management data relating to an owner of product assets and comprising product business model data of a third party; and
a processor coupled to the persistent storage unit to receive a request from a second server computing system over a first network, the request being for product asset management data relating to an owner of product assets, to collect the product asset management data relating to the owner, and to send the product asset management data to the second server computing system to allow the second server computing system to manage the product assets of the owner as specified by the third party via a second network.

10. The system of claim 9, wherein the product asset management data further comprises at least one of: third party extensions and client configuration data.

11. The system of claim 9, further comprising the processor:
to determine entitlements that are available to the owner, to determine entitlements to send to the second server computing system, and to mark the entitlements to be sent to the second server computing system as consumed.

12. The system of claim 9, wherein the second network is a private network.

13. A first server computing system comprising:
a persistent storage unit to store product asset management data from a second server computing system over a first network, the product asset management data relating to an owner of product assets and comprising product business model data of a third party; and
a processor coupled to the persistent storage unit to receive the product asset management data from the second server computing system over the first network, and to configure one or more entities in a second network to communicate with the first server computing system to manage the product assets of the owner as specified by the third party via the second network using the product asset management data stored in the persistent storage unit, the second network being a private network.

14. The system of claim 13, wherein the product asset management data further comprises at least one of: third party extensions and client configuration data.

15. The system of claim 13, wherein to configure one or more entities comprises the processor:
to configure an entity, using the client configuration data, to communicate with the first server computing system over the second network to consume a product.

16. The system of claim 14, further comprising the processor:
to send a request to the second computing system over the first network for updated product asset management data.

17. A non-transitory computer-readable storage medium including instructions that, when executed by a computer system, cause the computer system to perform a set of operations comprising:
receiving a request from a server computing system over a first network, the request being for product asset management data relating to an owner of product assets, the product asset management data comprising product business model data of a third party;
collecting the product asset management data relating to the owner; and
sending the product asset management data to the second server computing system to allow the second server computing system to manage the product assets of the owner as specified by the third party via a second network.

18. A non-transitory computer-readable storage medium including instructions that, when executed by a computer system, cause the computer system to perform a set of operations comprising:
receiving product asset management data from a server computing system over a first network, the product asset management data relating to an owner of product assets and comprising product business model data of a third party;
storing the product asset management data in a data store; and
managing the product assets of the owner as specified by the third party via a second network using the locally stored product asset management data.

19. The non-transitory computer-readable storage medium of claim 18, wherein configuring comprises:
configuring an entity, using the client configuration data, to communicate with the first server computing system over the second network to consume a product.

20. The non-transitory computer-readable storage medium of claim 18, further comprising:
sending a request to the second computing system over the first network for updated product asset management data.
